(19) United States
(12) Patent Application Publication
(10) Pub. No.: US 2010/0100421 A1
(43) Pub. Date: Apr. 22, 2010

(54) METHODOLOGY FOR SELECTING CAUSAL VARIABLES FOR USE IN A PRODUCT DEMAND FORECASTING SYSTEM

(76) Inventors: Arash Bateni, Toronto (CA); Edward Kim, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/255,696

(22) Filed: Oct. 22, 2008

(51) Int. Cl. G06Q 10/00

(52) U.S. Cl. 705/10

(57) ABSTRACT

A method to select causal factors to be used within a causal product demand forecasting framework. The methodology determines the set of factors that have statistically significant effects on historical product demand, and hence are believed to be of greatest relevance in determining product demand changes in the future. The effects of all factors are determined simultaneously and the net effect of each variable is calculated. When several factors are operative at the same time, the net influence of each factor is calculated. Lesser and redundant factors in the causal forecasting model can be eliminated to improve the stability, scalability and efficiency of the model. The method is employed to optimize causal models to achieve maximum forecast accuracy.

### CROSS REFERENCE TO RELATED APPLICATIONS

This application claims priority under 35 U.S.C. §119(e) to the following co-pending and commonly-assigned patent applications, which are incorporated herein by reference:

application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar, and J. P. Vorsanger; and

application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong.

### FIELD OF THE INVENTION

The present invention relates to methods and systems for forecasting product demand for retail operations, and in particular to a causal methodology, based on multiple regression techniques, for modeling the effects of various factors on product demand to better forecast future product demand patterns and trends.

### BACKGROUND OF THE INVENTION

Accurate demand forecasts are crucial to a retailer's business activities, particularly inventory control and replenishment, and hence significantly contribute to the productivity and profit of retail organizations. A causal framework has been developed by Teradata Corporation to better forecast future product demand patterns and trends, thereby improving the efficiency and reliability of inventory control and replenishment systems, and ultimately improve the productivity and profitability of retail organizations.

Potentially a wide range of factors, from competition to the weather, may influence demand for a product. Understanding and modeling the effect of numerous causal factors on the product demand on product demand is a sophisticated practice, partially due to the correlation or dependency of the numerous causal factors.

The improvement described herein is a methodology to select causal factors to be used within a causal forecasting framework. The methodology determines the set of factors that have statistically significant effects on historical product demand, and hence are believed to be of greatest relevance in determining product demand changes in the future. Lesser and redundant factors in the causal forecasting model can be eliminated to improve the stability, scalability and efficiency of the model. This methodology can be employed to optimize causal models to achieve maximum forecast accuracy.

### BRIEF DESCRIPTION OF THE DRAWINGS

FIG. 1 is a flow chart illustrating a method for determining product demand forecasts utilizing a causal methodology.

FIG. 2 is a flow chart illustrating an improved method for determining product demand forecasts, including a step for selecting regression variables in accordance with the present invention.

FIG. 3 is a flow chart illustrating a process for selecting causal variables to be used within a causal forecasting framework in accordance with the present invention.

FIG. 4 shows the structure of a database table for storing causal variable history information during variable selection in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

The demand forecasting technique described herein, referred to as a causal approach to demand forecasting, seeks to establish a cause-effect relationship between demand and the influencing factors in a market environment. Some of the factors having the most significant effect on a product's demand include price elasticity, promotion and decay, and seasonality. These factors, often attributes of the product itself, are referred to herein as primary variables. Secondary variables, variables which may or may not be significant for a given product, include events; cross-elasticity (cannibalization/affinity) related to the prices of other products; competitor activities, such as the promotion of similar products; weather; and suppliers campaigns.

application Ser. No. 11/938,812, referred to above, and incorporated by reference herein, describes a causal approach to demand forecasting. The demand forecasting technique described therein employs a multivariable regression model to model the causal relationship between product demand and the attributes of past promotional activities. The model is utilized to calculate the promotional uplift from the coefficients of the regression equation. The methodology consists of two main steps a) regression: calculation of regression coefficients, and b) coefficient transformation: calculation of the promotional uplift.

The methodology utilizes a mathematical formulation that transforms regression coefficients—a combination of additive and multiplicative coefficients—into a single promotional uplift coefficient that can be used for promotional demand forecasting. The multivariable regression equation can be expressed as:

demand=a+b·promoₖ+c·dcay+d·price+ Eq. (1)

Equation 1 includes causal variables promoₖ, a binary promotional flag for media type k; decay, a binary flag indicating the promotional decay; and price, the unit price for a given week. Regression coefficients included in equation 1 are: a, the intercept; b and c, the additive uplifts due to promotion or decay, respectively; and d, the multiplicative price elasticity. Additional coefficients and variables may also be included in equation 1.

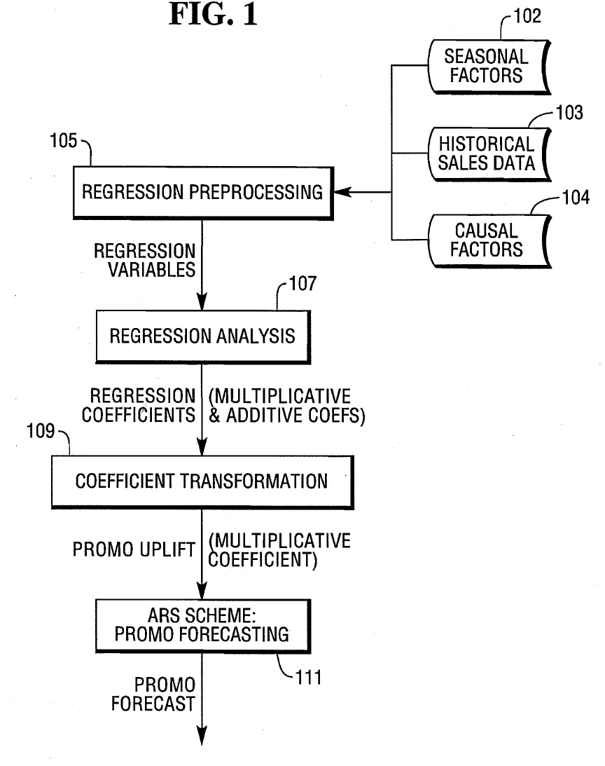

The procedure described in application Ser. No. 11/938,812 transforms the regression coefficients a, b , c, d, . . . into a single multiplicative uplift coefficient to be used in the forecasting scheme employed within the Teradata Corporation Demand Chain Management (DCM) application. FIG. 1 is a flow chart illustrating this casual method for forecasting product demand. As part of the DCM demand forecasting process, seasonal adjustment factors 102, historical sales data 103, and tracked causal factors 104, are saved for each product or service offered by a retailer.

In steps 105 and 107, regression coefficients (a, b, c, d, . . . ) are calculated using seasonal factors 102, historical sales data 103, and causal factors 104. These regression coefficients are combined in step 109 to generate a single, multiplicative promotional uplift coefficient.

In step 111, the promotional uplift is then input into the DCM Average Rate of Sale (ARS) calculations performed within the DCM application to estimate the promotional demand forecast.

The efficiency and scalability of a multivariable regression model to forecast product demand is reduced when a large number of causal variables are involved in the regression analysis. With a larger the number of variables, more historical data is required, and more computational time is needed, to calculate the regression coefficients. In addition, models with larger number of variables are generally more vulnerable to stability problems.

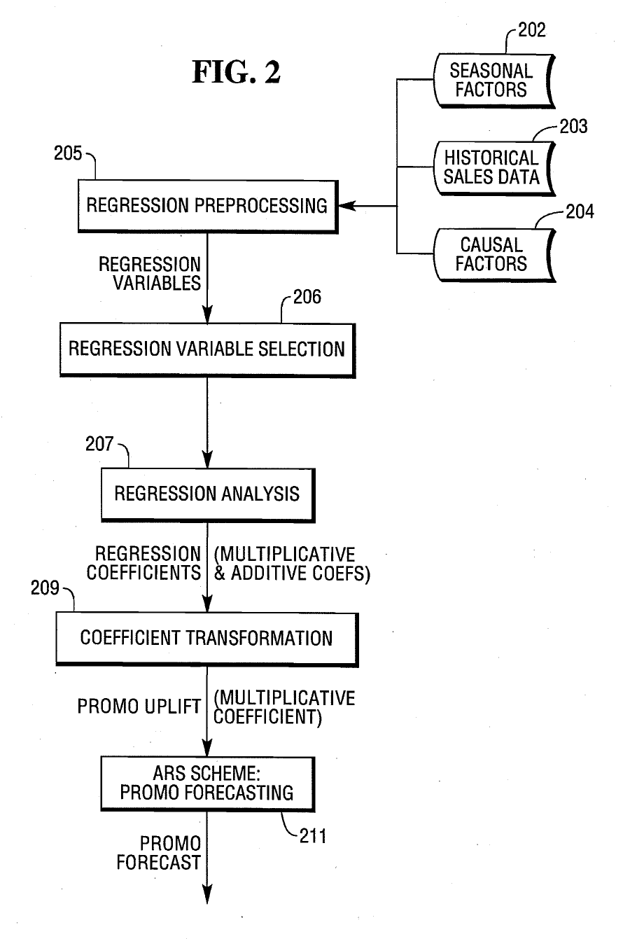

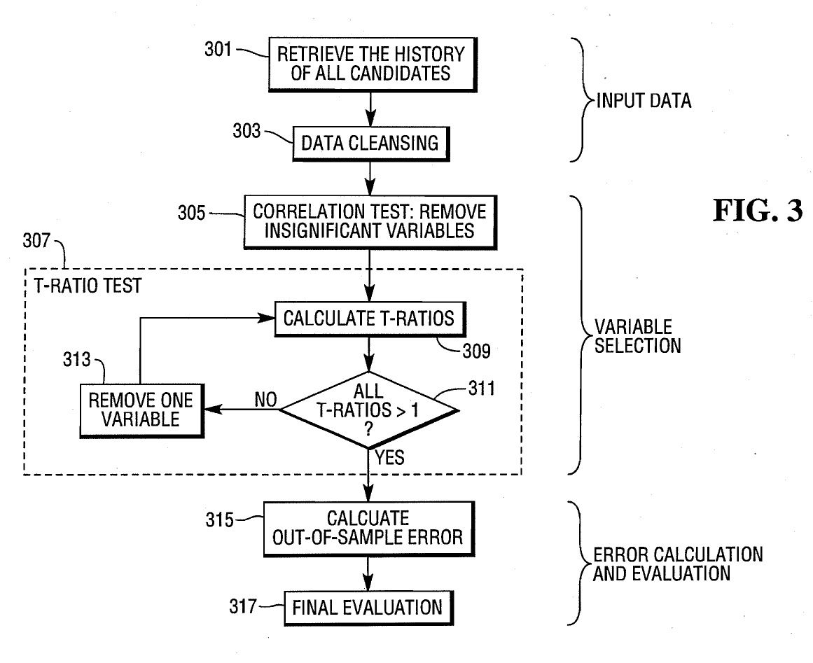

An improvement to the causal method discussed immediately above is illustrated in FIG. 2, wherein steps 205, 207, 209 and 211 of FIG. 2 correspond to steps 105, 107, 109 and 111 of FIG. 1. The improved causal method includes an additional step, step 206, for selecting causal variables prior to performing regression analysis in step 207. A process for selecting causal variables is illustrated in the flow chart of FIG. 3. In developing this process, several rules concerning the selection of causal variables were considered. These rules, labeled a through h, follow:
a. Management insight: Retail managers and business analysts often provide candidates for causal factors.
b. Significant relationship: All the causal variables should have a statistically significant correlation with demand.
c. Multi-variable analysis: The fitted multi-regression equation should result in statistically significant coefficients for all the variables. Insignificant variables are removed using a known t-ratio method. T-ratios are calculated for each coefficient by dividing the coefficient by the standard error. A large t-ratio indicates a less significant coefficient.
d. Predictive power: When the causal model is used for forecasting, it should be confirmed that each causal variable improves the predictive power of the model. This is done using an out of sample test.
e. Efficiency and scalability: The larger the number of variables the more computational time is needed to calculate the coefficients; so number of variables negatively affects the scalability of the model.
f. Stability: Generally, models with larger number of variables are more vulnerable to stability problems.
g. Historical data: More history is needed as the number of variables is increased. As a rule of thumb, the number of complete weeks of history divided by the number of variables should exceed 20. Actual sales data is not altered.
h. Business requirements: In unusual cases, causal variables may be added to the model although enough data or analytical proof is not available (e.g. t-ratio test may suggest removal of weather variable for a product but business analysts have strong opinion that it should be included.).

Referring now to FIG. 3, the process for selecting causal variables will now be described. Initially, all causal variable candidates should be considered as some variables may be significant for some products but not for others.

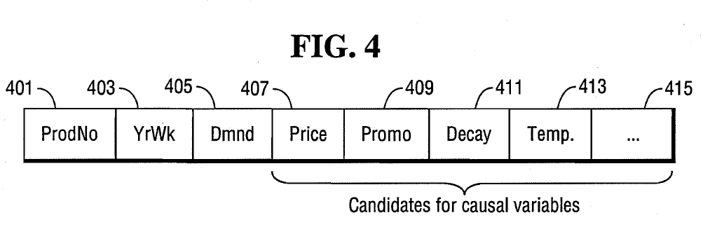

The process of FIG. 3 begins with the retrieval of historical sales data and causal factor data for a product from data storage in step 301. The history of the product's demand (dependant variable) and all other variables (candidates) required for the selection analysis are stored in a table with one column per variable, as illustrated in FIG. 4. FIG. 4 shows one row of the table. Data stored within the table for each week of product demand includes: a product number identification, ProdNo 401; an identification of the week and year of the demand data, YrWk 403; the product demand for the identified week, Dmnd 405; primary causal variables Price 407 (calculated as total dollars/total demand), Promo 409, and Decay 411; and secondary causal variables Temp 413 and 415. The causal variables identified in FIG. 4 are not intended to comprise a complete listing of possible variables. Additional and other causal variables may be tracked and retrieved for evaluation.

In step 303 data cleansing is performed to remove product demand data corresponding to a stock-out condition, and to remove incomplete weeks, e.g., when the value of one or more variables is missing. In step 305 the correlation of demand with each of the causal variables is calculated. If the correlation is insignificant, the variable is removed from the regression equation in accordance with rule b above.

In step 307, a multi-regression model is constructed with regression coefficients calculated for each of the causal factors that passed step 305. T-ratios are calculated for each coefficient (step 309) and the variables with smallest absolute t-ratios, are removed iteratively, until the absolute value of all t-ratios>1 (steps 311 and 313). These steps implement rule c above.

In step 315 an out-of-sample error calculation is performed to confirm that all the variables contribute to forecast accuracy, i.e., the accuracy is deteriorated if any of the variables is removed (see rule d). This step calculates the out-of-sample error and does not perform any test. It is recommended that the process be repeated with different variable sets to confirm that each variable is actually contributing to forecast accuracy.

A final evaluation to verify coefficient selection is performed in step 317. Tests are performed to verify that the amount of historical data is adequate to support the selection process, e.g. the number of complete weeks of history divided by the number of variables exceeds 20 (see rule g). Large scale tests may be needed to evaluate the efficiency and scalability of the model (see rule e).

The regression variable selection process described herein to establishes a cause and effect relationship between product demand and demand influencing factors through the identification of influencing variables, and the determination of the magnitude of each variable's effect on product demand. The effects of all variables are determined “simultaneously”. The “net” effect of each variable is calculated. When several factors are operative at the same time, the net influence of each factor is calculated.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting product demand for a product, the method comprising the steps of:
maintaining a database of historical product demand information and causal variable data;
analyzing said historical product demand information and causal variable data to identify causal variables having statistically significant effects on the historical product demand for said product;
analyzing said historical product demand information and causal variable data for said product to determine regression coefficients corresponding to said causal variables;
blending said regression coefficients and corresponding causal factors for said product to determine a product demand forecast for said product.

2. The method for forecasting product demand for a product in accordance with claim 1, further comprising the steps of:
constructing a multivariable regression equation defining a relationship between product demand, said causal variables, and said corresponding regression coefficients;
calculating t-ratios for each regression coefficient corresponding to said causal variables; and
for each regression coefficient having a t-ratio below a predetermined value, removing the regression coefficient having a t-ratio below said predetermined value and its corresponding causal variable from said multivariable regression equation.

3. The method for forecasting product demand for a product in accordance with claim 2, wherein said predetermined value is 1.

4. The method for forecasting product demand for a product in accordance with claim 1, wherein said causal variables include at least one of the following:
product price;
product promotion;
product seasonality;
prices of related products;
competitor activities;
weather; and
supplier product promotions.

5. A method for forecasting product demand for a product, the method comprising the steps of:
maintaining a database of historical product demand information and causal variable data;
retrieving historical product demand information and causal variable data for said product from said database;
analyzing said historical product demand information and causal variable data retrieved from said database to identify causal variables having statistically significant effects on the historical product demand for said product;
generating a multivariable regression equation defining a relationship between product demand and said causal variables;
analyzing said historical product demand information and causal variable data retrieved from said database to determine regression coefficients corresponding to said causal variables;
blending said regression coefficients and corresponding causal variables in accordance with said multivariable regression equation to determine a product demand forecast for said product.

6. The method for forecasting product demand for a product in accordance with claim 5, further including the step of:
prior to performing said step of analyzing said historical product demand information and causal variable data retrieved from said database to identify causal variables having statistically significant effects on the historical product demand for said product, removing incomplete product demand information and causal variable data from said retrieved historical product demand information and causal variable data.

7. The method for forecasting product demand for a product in accordance with claim 5, further comprising the steps of:
calculating t-ratios for each regression coefficient corresponding to said causal variables; and
for each regression coefficient having a t-ratio below a predetermined value, removing the regression coefficient having a t-ratio below said predetermined value and its corresponding causal variable from said multivariable regression equation.

8. The method for forecasting product demand for a product in accordance with claim 7, wherein said predetermined value is 1.

9. The method for forecasting product demand for a product in accordance with claim 5, wherein said causal variables include at least one of the following:
product price;
product promotion;
product seasonality;
prices of related products;
competitor activities;
weather; and
supplier product promotions.
